(19) United States
(12) Patent Application Publication
(10) Pub. No.: US 2024/0091854 A1
(43) Pub. Date: Mar. 21, 2024

(54) METAL POWDER INJECTION MOLDING SYSTEM FOR METALLIC FRAME AND THE MANUFACTURING METHOD FOR METALLIC FRAME USING THE SYSTEM

(71) Applicant: PIM KOREA CO., LTD., Daegu (KR)

(72) Inventor: Jun Ho SONG, Daegu (KR)

(73) Assignee: PIM KOREA CO., LTD., Daegu (KR)

(21) Appl. No.: 18/521,427

(22) Filed: Nov. 28, 2023

Related U.S. Application Data
(63) Continuation of application No. PCT/KR22/07889, filed on Jun. 3, 2022.

(30) Foreign Application Priority Data
Jun. 10, 2021 (KR) 10-2021-0075321
Jun. 10, 2021 (KR) 10-2021-0075322
Apr. 25, 2022 (KR) 10-2022-0050559
Apr. 25, 2022 (KR) 10-2022-0050565
Apr. 25, 2022 (KR) 10-2022-0050569

(51) Int. Cl. B22F 3/22; B22F 3/10; B22F 5/00

(52) U.S. Cl. CPC B22F 3/225; B22F 3/1021; B22F 5/00; B22F 2301/35; B22F 2302/45; B22F 2998/10

(57) ABSTRACT

The present invention relates to a method for manufacturing a basic metallic frame product used to produce a metallic frame as a part of an electronic product such as a smartphone, a smart key, a remote controller, and the like, and to a metal injection molded system including a metal injection molded product made with a mixture of metal powder and a binder and a support means for fixing the metal injection molded product to prevent the molded side walls from shrinking in the longitudinal directions thereof during a sintering process of the metal injection molded product. As the basic metallic frame product made using the system is provided, the metallic frame may be easily mass-produced, the production cost of the metallic frame may be lowered, and an amount of metal consumed for making the metallic frame may be reduced.

### CROSS-REFERENCE TO RELATED APPLICATION(S)

This application is a bypass continuation application of International Application No. PCT/KR2022/007889, filed on Jun. 3, 2022, which claims priority from Korean Patent Application No. 10-2021-0075321, filed on Jun. 10, 2021; Korean Patent Application No. 10-2021-0075322, filed on Jun. 10, 2021; Korean Patent Application No. 10-2022-0050559, filed on Apr. 25, 2022; Korean Patent Application No. 10-2022-0050565, filed on Apr. 25, 2022; and Korean Patent Application No. 10-2022-0050569, filed on Apr. 25, 2022, in the Korean Intellectual Property Office, the disclosures of which are incorporated herein by reference in their entireties.

### TECHNICAL FIELD

The present invention relates to a method for manufacturing a metallic edge (frame) used as a part of an electronic product such as a smartphone, a smart key, a remote controller, and the like, more specifically to a metal injection molded system that is newly configured to make a metallic frame through sintering of metal powder and a method for manufacturing a metallic frame.

That is, the present invention relates to a method for manufacturing a metallic frame using a sintered metal not applied in manufacturing the metallic frame in conventional practices, more specifically to a metal injection molded system having a new shape and function applied in producing a metallic frame using a sintered metal and to a method for manufacturing a metallic frame using the system.

### BACKGROUND ART

A metallic frame is widely used to improve the strength and aesthetics of electronic products such as a smartphone, a smart key, a remote controller, and the like.

A conventional metallic frame is made through a lot of processes (in the past, 30 processes needed in Pantech) such as a metal lump cutting process, a cut metal machining process, and the like.

According to the conventional method for making the metallic frame, an amount of waste metal during the cutting and machining processes is larger than an amount of metal used as a finished product, and therefore, a raw material loss undesirably increases. Further, most of the production cost is occupied by the machining cost, not by the metal price of the metallic frame itself.

In spite of many advantages the metallic frame has, therefore, companies producing finished products, such as Samsung Electronics Co., Ltd., etc. do not adopt such metallic frames for a long time because of high production costs and supply and demand problems of the metallic frames.

Metal Injection Molding (MIM) is a process in which general plastic injection molding is combined with metal powder sintering developed in a powder metallurgy field.

The metal injection molding is possible to make three-dimensional precision parts with all powder materials such as metals, ceramic, hard metals, intermetallic compounds, and the like and capable of molding precise and complex parts such as materials with difficult machinability or materials impossible in casting up to a step in which post-machining is barely required, so that the metal injection molding advantageously ensures mass production.

If it is desired to inject high gravity metal powder into a mold, a binder in which resin and wax are mixed is mixed with the metal powder to improve metal powder binding and fluidity during the injection, and in this case, a quality of an injection molded product may be varied according to the properties of the binder. Further, a debinding process of removing the binder is required, which affects the quality and productivity of a sintered product made out of the injection molded product.

Besides, the injection molded product may shrink when sintered, and accordingly, in the case of a part such as a metallic frame that has a relatively lower thickness and a relatively smaller width when compared with its entire size, tries to make the metallic frame, using the metal injection molding through which the part may be easily deformed and broken by a sintering process, have been not found yet.

### SUMMARY

The present invention relates to a method for manufacturing a metallic frame inserted into a casing of an electronic product such as a smartphone, a smart key, and the like, while solving the problems the conventional technologies have had.

Accordingly, it is an object of the present invention to provide a method for manufacturing a metallic frame that does not need to require a process of making a metallic frame through a metal lump cutting process and a cut metal machining process because the process is extremely labor-intensive and makes individual products one by one, thereby making it hard to achieve mass production.

It is another object of the present invention to provide a method for manufacturing a metallic frame that is capable of solving the problems the conventional metallic frame making method, in which numerous individual processes are needed to cause a lot of time and a high manufacturing cost, has had.

It is yet another object of the present invention to provide a method for manufacturing a metallic frame that is capable of solving the problems the conventional metallic frame making method, in which an amount of metal waste after a cutting process is larger than an amount of metal produced as a metallic frame, had had.

The present invention relates to a method for manufacturing a metallic frame for an electronic part using a sintered metal not applied in conventional practices, more specifically to a method for manufacturing a basic metallic frame product that includes the steps of making a metal injection molded product using metal injection molding, sintering the metal injection molded product, and producing the basic metallic frame product, a metal injection molded product having a new shape and function used in the method, and a system comprising the metal injection molded product.

According to the present invention, a metal injection molded system may include: a metal injection molded product having molded side walls to make a metallic frame in such a way as to allow the molded side walls to intersect to provide the metal injection molded product having a closed shape; and support means disposed at the insides of corners at which the molded side walls intersect to fix the molded side walls thereto so that the molded side walls are prevented from shrinking in longitudinal directions thereof during a sintering process.

The support means may fix the molded side walls thereto to prevent the molded side walls from shrinking in the longitudinal directions thereof during the sintering process and may be configured to be separable from the molded side walls after the sintering process.

As shown in FIG. 1, a basic metallic frame product requires relatively thinner and longer molded side walls when compared with the entire size thereof, and it is not easy to make a metal injection molded product having such thinner and longer molded side walls through a sintering process.

This is because the molded side walls may shrink when the metal injection molded product is sintered, thereby causing deformation such as twisting and breakage such as cutting on the molded side walls.

According to the present invention, the metal injection molded system may be configured to allow the insides of the corners of the molded side walls to be fixedly supported against separate support means so that the molded side walls are prevented from being deformed and broken during the sintering process.

According to the present invention, the support means may include inside corner supports fixed to one surface thereof, and the inside corner supports may be freely changed in shape according to the shapes of intersecting portions of the molded side walls only if they prevent the molded side walls from shrinking in the longitudinal directions thereof. That is, if the corners of the molded side walls are rounded, round inside corner supports may be provided, and otherwise, inside corner supports rounded only on the portions coming into contact with the rounded corners of the molded side walls may be provided.

The inside corner supports and the support means may be configured to be easily separated from the metal injection molded product after the sintering process. That is, the inside corner supports and the support means may include a ceramic material, or the inside corner supports and the support means may be treated to have no reaction to the molded side walls of the metal injection molded product.

The treatment through which the inside corner supports and the support means do not react to the molded side walls may be performed by selecting one among (a) a method in which the inside corner supports and the support means are entirely made of an unreactive material that does not react to the molded side walls, (b) a method in which an unreactive material that does not react to the molded side walls is applied to the outer surfaces of the inside corner supports and the support means, and (c) a method in which an unreactive material or solution is applied to any one or more surfaces where the inside corner supports and/or support means are brought into contact with the molded side walls and then dried or sintered.

According to the present invention, the metal injection molded product may include a mixture of metal powder and a binder, and the metal powder may include one selected from molybdenum, tungsten, and an alloy thereof; alloy steel with Fe as a main component; stainless alloy steel such as SUS630, SUS316, and SUS304; and titanium and titanium alloys, or a combination of two or more thereof, desirably the metal powder may include stainless steel alloy or titanium hydride.

The mixture of the metal powder and the binder may comprise: 47.5 to 65% by volume of stainless steel alloy powder; and 52.5 to 35% by volume of the binder comprising 40 to 60% by weight of wax and 60 to 40% by weight of polymers, desirably comprise 55 to 60% by volume of stainless steel alloy powder; and 45 to 40% by volume of the binder comprising 40 to 60% by weight of wax and 60 to 40% by weight of polymers.

The binder may comprise 45 to 55% by weight of paraffin wax, 1 to 10% by weight of carnauba wax, 10 to 20% by weight of polypropylene, 25 to 35% by weight of polyacetal, and 1 to 10% by weight of amorphous polyalphaolefin, desirably comprise 45 to 50% by weight of paraffin wax, 1 to 5% by weight of carnauba wax, 10 to 15% by weight of polypropylene, 25 to 30% by weight of polyacetal, and 1 to 5% by weight of amorphous polyalphaolefin.

According to the present invention, the mixture of the metal powder and the binder may comprise: 45 to 75% by volume of titanium hydride powder; and 55 to 25% by volume of the binder comprising 40 to 60% by weight of wax and 60 to 40% by weight of polymers, and the binder may desirably comprise 40 to 60% by weight of paraffin wax, 15 to 30% by weight of polypropylene, 10 to 30% by weight of polyethylene, and 1 to 10% by weight of amorphous polyalphaolefin, more desirably comprise 55 to 60% by weight of paraffin wax, 15 to 20% by weight of polypropylene, 15 to 20% by weight of polyethylene, and 1 to 5% by weight of amorphous polyalphaolefin.

In the case where the metal injection molded product is made out of the mixture of the metal powder and the binder in which titanium hydride is used as the metal powder, at the time when the metal injection molded product is fixed to the support means, there is a need to keep a given distance (restrained gap) between the insides of the corners of the molded side walls and the inside corner supports. This is because hydrogen is lost, when titanium hydride is sintered, so that the metal injection molded product using titanium hydride powder may shrink to a larger extent than the metal injection molded product using the stainless steel alloy powder. Accordingly, if the molded side walls and the inside corner supports are disposed to come into close contact with each other (that is, if a restrained gap therebetween is 0%), the molded side walls may be twisted or cracked when sintered.

The restrained gap may be in the range of 1.5 to 5.5%, more desirably in the range of 1.5 to 5%.

According to the present invention, the metal injection molded product may have a polygonal shape, and a portion of each inside corner support may have the shape corresponding to the inside of each corner of the polygonal metal injection molded product.

According to the present invention, the metal injection molded system may allow a plurality of metal injection molded products to be subjected to the sintering process at a time.

According to an embodiment of the present invention, the metal injection molded system may be configured to allow the plurality of metal injection molded products fixed correspondingly to a plurality of support means to be stacked on top of one another and to allow the inside corner supports to be provided to the forms of multi-connection inside corner supports disposed to pass through the corresponding support means in such a way as to be locked onto the insides of the corners of the plurality of metal injection molded products.

According to another embodiment of the present invention, the metal injection molded system may be configured to allow a plurality of metal injection molded products to be spaced apart from one another in a stacked manner by means of spacing members and to allow the inside corner supports fixed to the support means to be provided to the forms of multi-connection inside corner supports locked onto the insides of the corners of the plurality of metal injection molded products.

According to yet another embodiment of the present invention, the metal injection molded system may be configured to allow two support means to stand up to face each other, while a plurality of metal injection molded products are spaced apart from one another in a stacked manner by means of spacing members between the two support means, and to allow the inside corner supports fixed to the two support means to be provided to the forms of multi-connection inside corner supports locked onto the insides of the corners of the plurality of metal injection molded products.

According to the present invention, the metal injection molded system may further include guide members for supporting any one or more among the inner surfaces, the outer surfaces, the inner and outer surfaces, the width directions, and the thickness directions of the molded side walls.

The guide members may support the inner surfaces, the outer surfaces, the inner and outer surfaces, or the width directions of the molded side walls as well as the thickness directions thereof. Accordingly, the guide members may freely change the shape of the basic metallic frame product so that the basic metallic frame product may be made to various shapes. Further, the guide members may be added to portions of the molded side walls if the molded side walls are long to be difficult to be supported only with the inside corner supports, thereby preventing the molded side walls from being deformed during the sintering process.

According to the present invention, the guide members may be configured to have no reaction to the molded side walls.

Using the metal injection molded system, there is provided a method for manufacturing a basic metallic frame product, the method including the steps of: designing a shape of a product to be made by metal injection molding; making a mold based on the designed shape; mixing metal powder and a binder to make a mixture of the metal powder and the binder; injecting the mixture into the mold made according to the shape of the product to be made by the metal injection molding to make a metal injection molded product having molded side walls to make a metallic frame in such a way as to allow the molded side walls to intersect to provide the metal injection molded product having a closed shape; allowing the metal injection molded product to be subjected to supercritical debinding and thermal debinding, fixed to support means disposed on the insides of corners at which the molded side walls intersect to prevent the molded side walls from shrinking in longitudinal directions thereof during a sintering process, and subjected to the sintering process; and separating the basic metal frame product from the support means.

The mixture of the metal powder and the binder may comprise: 55 to 60% by volume of stainless steel alloy powder; and 45 to 40% by volume of the binder comprising 45 to 55% by weight of paraffin wax, 1 to 10% by weight of carnauba wax, 10 to 20% by weight of polypropylene, 25 to 35% by weight of polyacetal, and 1 to 10% by weight of amorphous polyalphaolefin, desirably comprising 45 to 50% by weight of paraffin wax, 1 to 5% by weight of carnauba wax, 10 to 15% by weight of polypropylene, 25 to 30% by weight of polyacetal, and 1 to 5% by weight of amorphous polyalphaolefin.

According to the present invention, the mixture of the metal powder and the binder may comprise: 45 to 75% by volume of titanium hydride powder; and 55 to 25% by volume of the binder comprising 40 to 65% by weight of paraffin wax, 15 to 30% by weight of polypropylene, 10 to 30% by weight of polyethylene, and 1 to 10% by weight of amorphous polyalphaolefin, desirably comprising 55 to 60% by weight of paraffin wax, 15 to 20% by weight of polypropylene, 15 to 20% by weight of polyethylene, and 1 to 5% by weight of amorphous polyalphaolefin.

If the mixture of the metal powder and the binder comprises the titanium hydride powder, the restrained gap between the support means and the metal injection molded product may be in the range of 1.5 to 5.5%, desirably in the range of 1.5 to 5%.

According to the present invention, a new method is provided to manufacture a metallic frame inserted into a casing of an electronic product such as a smartphone, a smart key, and the like, thereby allowing the metallic frame to be easily mass-produced and lowering a production cost of the metallic frame. Further, the method according to the present invention has a smaller amount of metal used than the conventional metallic frame manufacturing method, thereby providing resource saving effects.

### BRIEF DESCRIPTION OF DRAWINGS

FIG. 1 shows a basic metallic frame product manufactured by a metal injection molded product for a metallic frame according to the present invention.

FIG. 2 shows a metal injection molded system according to one embodiment of the present invention in which a metal injection molded product for a metallic frame and a support means are provided.

FIG. 3 shows examples of an inside corner support based on the shapes of molded side walls according to the present invention.

FIGS. 4 to 6 show metal injection molded systems according to other embodiments of the present invention in which two or more metal injection molded products are stacked on top of one another and sintered at a time.

FIG. 7 shows a metal injection molded system according to another embodiment of the present invention in which guide members are further provided to make the thicknesses, widths, etc. of the molded side walls formed differently in shape.

Hereinafter, explanations of reference numerals in the drawings will be given below.
100, 200, 400, 500, 600, 700: Side wall
501, 502, 503, 504: Corner
514, 614, 714: Support means
700a: Spacing member
242, 441, 541, 542, 543, 641, 742: Inside corner support or multi-connection inside corner support
150: Guide member

### DETAILED DESCRIPTION

Objects, characteristics and advantages of the present invention will be more clearly understood from the detailed description as will be described below and the attached drawings. Before the present invention is disclosed and described, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure.

Terms used in this application are used to only describe specific exemplary embodiments and are not intended to restrict the present invention. An expression referencing a singular value additionally refers to a corresponding expression of the plural number, unless explicitly limited otherwise by the context. In the description, when it is said that one portion is described as “comprises” and/or “comprising” any component, one element further may include other components unless no specific description is suggested.

All terms used herein, including technical or scientific terms, unless otherwise defined, have the same meanings which are typically understood by those having ordinary skill in the art. The terms, such as ones defined in common dictionaries, should be interpreted as having the same meanings as terms in the context of pertinent technology, and should not be interpreted as having ideal or excessively formal meanings unless clearly defined in the specification.

Hereinafter, embodiments of the present invention will be described in detail with reference to the attached drawings.

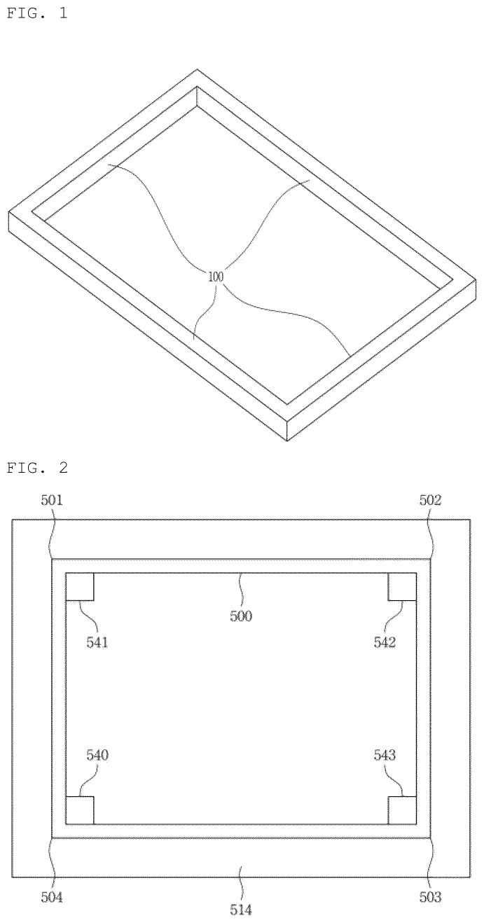

FIG. 1 shows an example of a basic metallic frame product, to which the present invention is applied, before a square-shaped metallic frame having four side walls 100 intersecting with one another is made, and in this case, the metallic frame is made with a concept wherein it is made out of a metal injection molded product for a metallic frame and a concept wherein sintering time remarkably extends longer than that when a conventional sintered metal, thereby minimizing its longitudinal shrinkage, without any damage in debinding and sintering processes.

The basic metallic frame product has the shape of square, but it may be freely changed according to the shapes of a casing or the like of electronic products. If the corners of the casing of the electronic product are rounded, the corners of the basic metallic frame product are also rounded.

In this case, the term “basic metallic frame product” represents a final product of the present invention before it is machined to turn into a metallic frame. In detail, the basic metallic frame product is a product obtained by separating the metal injection molded product made through a sintering process in a state of being fixed to a support means from the support means.

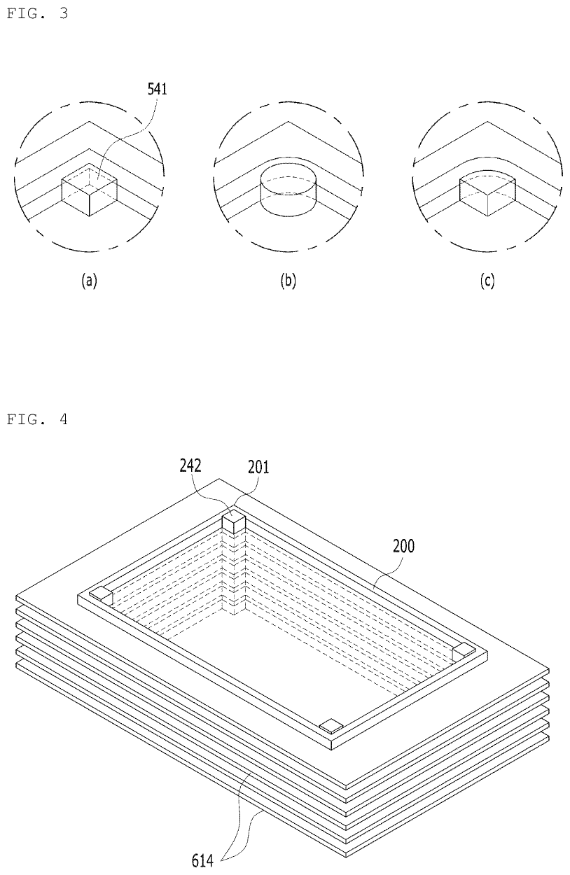

FIG. 2 shows a metal injection molded system according to one embodiment of the present invention in which a metal injection molded product for a metallic frame and a support means are provided.

As shown, the metal injection molded system includes a square-shaped metal injection molded product having four molded side walls 100 intersecting with one another; and a support means 514 having four inside corner supports 540 to 543 disposed at the insides of corners 501 to 504 of the metal injection molded product.

That is, FIG. 2 shows an example of the metal injection molded system for making the basic metallic frame product as shown in FIG. 1.

The inside corner supports 540 to 543 are fixedly fastened to one surface of the support means 514 to allow the molded side walls 100 to be resistant to shrinking forces thereof in the longitudinal directions during the sintering process of the metal injection molded product. That is, the insides of the corners of the molded side walls are fixed to the inside corner supports to allow the molded side walls of the metal injection molded product to be kept in shape during the sintering process, thereby producing the basic metallic frame product having a desired dimension and shape.

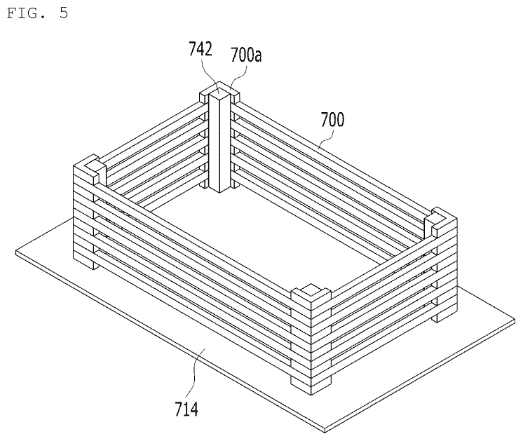

According to the embodiment of the present invention, the square-shaped inside corner supports are provided according to the shapes of the corners of the molded side walls (see (a) of FIG. 3), but the inside corner supports may be freely changed in shape according to the shapes of intersecting portions of the molded side walls only if they prevent the molded side walls from shrinking in the longitudinal directions thereof. That is, if the corners of the molded side walls are rounded, round inside corner supports may be provided (see (b) of FIG. 3), and otherwise, inside corner supports rounded only on the portions coming into contact with the rounded corners of the molded side walls may be provided (see (c) of FIG. 3).

The inside corner supports and the support means are configured to be easily separated from the metal injection molded product after the sintering process. That is, the inside corner supports and the support means include a ceramic material, or the inside corner supports and the support means are treated to have no reaction to the molded side walls of the metal injection molded product.

The treatment through which the inside corner supports and the support means do not react to the molded side walls is performed by selecting one among a method in which the inside corner supports and the support means are entirely made of an unreactive material that does not react to the molded side walls, a method in which an unreactive material that does not react to the molded side walls is applied to the outer surfaces of the inside corner supports and the support means, and a method in which an unreactive material or solution is applied to any one or more surfaces where the inside corner supports and/or support means are brought into contact with the molded side walls and then dried or sintered. The unreactive material includes any one of ceramic powder and graphite powder or a combination of two or more thereof.

Hereinafter, an explanation of a mixture of metal powder and a binder required to manufacture the metal injection molded product will be given.

The metal injection molded product according to the present invention is made through metal injection molding using a mixture of metal powder and a binder.

That is, the metal powder is injection molded to an appropriate shape, and the metal powder is subjected to ceramic sintering, metal sintering, or combined sintering thereof.

To make the metal injection molded product, the binder (bonding agent) as well as the metal powder is used to apply the fluidity to the metal powder and to keep the shape of the metal powder, and the binder has wax and various polymers as main components. If the binder is used, of course, a process of removing the binder has to be additionally performed.

The injection molding mixture in which the metal powder and the binder are mixed is injection molded through a general plastic precision injection molding machine, and accordingly, metal injection molded products having various shapes may be made using the injection molding machine.

According to the present invention, the metal injection molded product includes metal powder and a binder, and the metal powder comprises one selected from molybdenum, tungsten, and an alloy thereof; alloy steel with Fe as a main component; stainless alloy steel such as SUS630, SUS316, and SUS304; and titanium and titanium alloys or a combination of two or more thereof, and desirably, the metal powder is titanium hydride or stainless alloy steel.

The binder used to make the metal injection molded product includes various wax and various polymers, and desirably, the wax includes paraffin wax, carnauba wax, and a mixture thereof. Desirably, the polymers include polyacetal (POM), polypropylene (PP), polyethylene (PE), amorphous polyalphaolefin (APA), and a combination of two or more thereof.

One exemplary process of manufacturing the metal injection molded product is as follows.

1) Kneading

The kneading step is a process of mixing metal powder and a binder. A kneading machine is pre-heated to a temperature between 100 and 250° C., and pre-weighed metal powder and binder are poured into the kneading machine to make a mixture thereof. For example, the metal powder and the binder are poured and mixed in the kneading machine set to a temperature between 100 and 250° C., desirably to a temperature between 140 and 170° C., and in this case, the binder is melted to permeate the metal powder because of high temperature so that the binder and the metal powder are kneaded. This process is performed for about one to three hours to allow the binder to be uniformly mixed with the metal powder, so that the mixture of the metal powder and the binder is made.

2) Injection

The injection step is a process of pouring the mixture of the metal powder and the binder into an injection molding machine, moving the mixture to a mold through a nozzle, and making the shape of the metal injection molded product. The injection molding machine pushes the mixture of the metal powder and binder poured into a hopper through a screw and moves the mixture to the mold. In this case, desirably, a speed of the screw is in the range of 20 to 50 m/s, and a temperature of the nozzle is in the range of 120 to 150° C. The mixture discharged from the nozzle moves to the mold and is shaped as the product in the mold. When the mixture is subjected to injection molding, desirably, a holding pressure in the range between 800 and 1000 kgf is applied and a temperature of the mold is set to the range between 30 and 50° C.

3) Supercritical debinding

The supercritical debinding step is a process where carbon dioxide has a supercritical phase in which a diffusion speed is high and surface tension is low to remove wax from the metal injection molded product. The carbon dioxide having the supercritical phase quickly permeates the ultrafine pores of the metal injection molded product, removes the wax from the metal injection molded product, and is quickly discharged therefrom, thereby enabling effective debinding. Desirably, the supercritical debinding step is performed at a pressure of 200 to 250 bar and a temperature of 70 to 80° C. for 5 to 10 hours.

4) Thermal Debinding

The thermal debinding step is a process of applying heat to the metal injection molded product whose debinding is completed to remove the polymers as one of the components of the binder. The polymers remaining after the wax has been removed in the supercritical debinding step are subjected to heat treatment at a temperature greater than 300° C. and thus completely removed. Desirably, the thermal debinding step is kept under argon atmosphere at a temperature of 300° C. for 30 minutes and then kept at a temperature of 450° C. for 30 minutes.

5) Sintering

The sintering step is a process where the debinded metal injection molded product is subjected to sintering at a sintering furnace set to a temperature between 900 and 1600° C. to make a basic metallic frame product. At the temperature in the above-mentioned range, metal powder sintering is easily performed, and a sintered material has excellent mechanical strength and surface properties. If the sintering temperature is less than 900° C., the surface properties and mechanical properties of the sintered material are deteriorated, and if the sintering temperature is greater than 1600° C., the mechanical properties of the sintered material are deteriorated. The sintering process is performed under gas atmosphere where any one of hydrogen and argon or both of them are contained or under vacuum. When the sintering process is performed under gas atmosphere or vacuum, oxidization occurring when oxygen is introduced can be prevented.

One of detailed embodiments where the metal injection molded product according to the present invention is made is as follows.

One of stainless steel, SUS316 is used as the metal powder and mixed with the binder at volume ratios as listed in Table 1 to make the mixtures of the metal powder and the binder. In Table 1, a composition ratio between the wax and the polymers constituting the binder is represented by % by weight, and a composition ratio between the metal powder and the binder constituting the mixture is represented by % by volume.

Metal powder having particle sizes of 2 to 20 μm is used as the metal powder for making the SUS metal injection molded product. Various types of wax and various types of polymers are used as the binder. Desirably, paraffin wax, carnauba wax, and a mixture thereof that have a melting point of 55 to 75° C. and a density of 0.85 to 0.92 may be used as the wax, and polyacetal (POM) having a melting point of 140 to 170° C. and a density of 1.05 to 1.20, polypropylene (PP) having a melting point of 130 to 165° C. and a density of 0.85 to 0.97, polyethylene (PE) having a melting point of 95 to 135° C. and a density of 0.91 to 0.97, amorphous polyalphaolefin (APAO) having a melting point of 90 to 100° C. and a density of 0.85 to 0.92, and a combination of two or more thereof may be used as the polymers.

The binder desirably comprises 45 to 55% by weight of paraffin wax, 1 to 10% by weight of carnauba wax, 10 to 20% by weight of polypropylene, 25 to 35% by weight of polyacetal, and 1 to 10% by weight of amorphous polyalphaolefin, more desirably comprises 45 to 50% by weight of paraffin wax, 1 to 5% by weight of carnauba wax, 10 to 15% by weight of polypropylene, 25 to 30% by weight of polyacetal, and 1 to 5% by weight of amorphous polyalphaolefin.

The amorphous polyalphaolefin used as the polymers serves to improve the binding force of the mixture of the metal powder and the binder so that the metal injection molded product becomes stabilized in shape, thereby obtaining a good quality of basic metallic frame product when sintered.

The mixtures of the metal powder and the binder having the composition ratios as suggested in Table 1 are injected to a mold to make the metal injection molded product as shown in FIG. 2. The metal injection molded product has a horizontal length of 156 mm, a vertical length of 74 mm, and a thickness of 9 mm, and a width of each molded side wall has 7 mm.

Injection molding possibilities depending upon the composition ratios between the wax and the polymers of the binder and the composition ratios between the binder and the metal powder are suggested in ‘injection molding performance evaluation’ of Table 1.

A reference symbol ‘0’ represented on the injection molding performance evaluation means that the mixture of the metal powder and the binder is stably molded to the shape of the metal injection molded product, a reference symbol ‘A’ means that the mixture of the metal powder and the binder is kept to the shape of the metal injection molded product, but it has internal defects, and a reference symbol ‘X’ means that the mixture of the metal powder and the binder is not molded in the mold to the shape of the metal injection molded product.

As appreciated from Table 1, the mixtures of the metal powder and the binder comprising 27.5 to 57.5% by volume of the binder having 40 to 60% by weight of wax and 60 to 40% by weight of polymers and 72.5 to 42.5% by volume of the metal powder have good injection molding performance.

If the metal powder is greater than the above-mentioned percentage by volume, the mixture of the metal powder and the binder does not flow well to cause the injecting molding machine to be easily clogged, and further, the mixture may be easily attached to the mold. If the content of the metal powder is low, fluidity becomes high to fail to perform the molding, and further, the mold may be easily contaminated.

The metal injection molded product, which is stably molded, is subjected to supercritical debinding and thermal debinding, and next, it is fixed to the support means, as shown in FIG. 2 and subjected to sintering, thereby making a basic metallic frame product.

According to the present invention, further, the sintering is performed under the conditions where the sintering furnace is heated up to about 1300° C. and the heating is controlled to a heating rate of 0.5° C. or under lower than a heating rate of 1 to 5° C. per minute typically used. Through such an appropriate heating rate per minute, accordingly, the sintering is performed in a state where the insides of the corners of the molded side walls are restrained by the inside corner supports, that is, in a state where the longitudinal deformation of the molded side walls is suppressed, so that deformation occurs in directions excepting the longitudinal directions of the molded side walls to prevent the molded side walls from being broken.

The metal injection molded products made of the mixtures of the metal powder and the binder may be easily deformed due to shrinkage when sintered, and further, defects such as twists, cuts, and the like that are caused by the deformation may be made. The states of the basic metallic frame products made by sintering the metal injection molded products are represented as ‘sintered states’ of Table 1.

A reference symbol ‘⊚’ represented on the ‘sintered states’ means that the metal injection molded product is very stably sintered to the shape of the basic metallic frame product, a reference symbol ‘O’ means that the metal injection molded product is stably sintered to the shape of the basic metallic frame product, a reference symbol ‘Δ’ means that the metal injection molded product is sintered to be somewhat deformed, and a reference symbol ‘X’ means that the metal injection molded product is sintered to be seriously deformed and thus does not have the shape of the basic metallic frame product.

TABLE 1
Embodiments of metal injection molded products using mixtures of
SUS metal powder and binder

| | Mixtures for metal injection | | | | | |
|---|---|---|---|---|---|---|
| | molding (% by volume) | | | | | |
| | | Binder | | | | |
| | | | Composition | | | |
| | | | ratio | | Injection | |
| | | | (% by weight) | | molding | Sintered |
| Nos. | SUS316 | | Wax | Polymers | performance | states |
| Embodiment 1 | 40 | 60 | 30 | 70 | X | |
| Embodiment 2 | 42.5 | 57.5 | 40 | 60 | ◯ | X |
| Embodiment 3 | 45 | 55 | 50 | 50 | ◯ | X |
| Embodiment 4 | 47.5 | 52.5 | 60 | 40 | ◯ | ◯ |
| Embodiment 5 | 50 | 50 | 70 | 30 | X | |
| Embodiment 6 | 52.5 | 47.5 | 30 | 70 | X | |
| Embodiment 7 | 55 | 45 | 40 | 60 | ◯ | ⊚ |
| Embodiment 8 | 57.5 | 42.5 | 50 | 50 | ◯ | ⊚ |
| Embodiment 9 | 60 | 40 | 60 | 40 | ◯ | ⊚ |
| Embodiment 10 | 62.5 | 37.5 | 70 | 30 | X | |
| Embodiment 11 | 65 | 35 | 30 | 70 | X | |
| Embodiment 12 | 67.5 | 32.5 | 40 | 60 | ◯ | Δ |
| Embodiment 13 | 70 | 30 | 50 | 50 | ◯ | X |
| Embodiment 14 | 72.5 | 27.5 | 60 | 40 | ◯ | X |
| Embodiment 15 | 75 | 25 | 70 | 30 | X | |
| Embodiment 16 | 65 | 35 | 60 | 40 | ◯ | ◯ |
| Embodiment 17 | 65 | 35 | 40 | 60 | ◯ | ◯ |

As appreciated from Table 1, the metal injection molded products made of the mixtures of the metal powder and the binder comprising 35 to 52.5% by volume of the binder having 40 to 60% by weight of wax and 60 to 40% by weight of polymers and 65 to 47.5% by volume of the metal powder are sintered to good basic metallic frame products, more particularly the metal injection molded products made of the mixtures of the metal powder and the binder comprising 40 to 45% by volume of the binder having 40 to 60% by weight of wax and 60 to 40% by weight of polymers and 60 to 55% by volume of the metal powder are sintered to very good basic metallic frame products.

In the case where the binder desirably comprises 45 to 55% by weight of paraffin wax, 1 to 10% by weight of carnauba wax, 10 to 20% by weight of polypropylene, 25 to 35% by weight of polyacetal, and 1 to 10% by weight of amorphous polyalphaolefin, injection molding performance and sintered states are good, and in this case, the binder more desirably comprises 45 to 50% by weight of paraffin wax, 1 to 5% by weight of carnauba wax, 10 to 15% by weight of polypropylene, 25 to 30% by weight of polyacetal, and 1 to 5% by weight of amorphous polyalphaolefin.

According to the above-mentioned embodiments, the basic metallic frame product having the shape as shown in FIG. 2 is made, but without being limited thereto, the embodiments may be applied to make metallic frame basis products having various shapes and thicknesses.

The metal injection molded products after sintered are separated from the inside corner supports of the support means to obtain the basic metallic frame product as shown in FIG. 1.

Another detailed embodiment where the metal injection molded product according to the present invention is made is as follows.

Titanium hydride having particle sizes of 5 to 30 μm is used as metal powder and kneaded with a binder at the volume ratios as listed in Table 2, thereby making mixtures of the metal powder and the binder.

Titanium is a non-magnetic material having low thermal expansion coefficient and excellent oxidation resistance and has better strength and lower specific gravity than other metals such as SUS alloy steel, carbon steel, and the like, thereby advantageously making a lightweight basic metallic frame product. Contrarily, titanium has a high melting point and difficulty machinability, and accordingly, it is hard to mass-produce the metallic frames made of titanium.

Further, in the case of titanium hydride to which the metal injection molding is applied, the metal injection molded product may greatly shrink by the dehydrogenation reaction of titanium hydride when sintered, so that it is more difficult that the metallic frame is made using the metal injection molded product with the titanium hydride than with the stainless steel alloy.

A process of making the basic metallic frame product using titanium hydride is the same as of making the basic metallic frame product using the SUS metal powder unless no specific description is suggested.

In the case where titanium hydride is used as the metal powder, a desirable composition of the binder is as follows.

The binder desirably comprises 40 to 60% by weight of paraffin wax having a melting point of 55 to 75° C. and a density of 0.85 to 0.92, 15 to 30% by weight of polypropylene having a melting point of 130 to 165° C. and a density of 0.85 to 0.97, 10 to 30% by weight of polyethylene having a melting point of 95 to 135° C. and a density of 0.91 to 0.97, and 1 to 10% by weight of amorphous polyalphaolefin having a melting point of 90 to 100° C. and a density of 0.85 to 0.92, more desirably comprises 55 to 60% by weight of paraffin wax, 15 to 20% by weight of polypropylene, 15 to 20% by weight of polyethylene, and 1 to 5% by weight of amorphous polyalphaolefin.

Injection molding possibilities depending upon the composition ratios between the wax and the polymers of the binder and the composition ratios between the binder and the metal powder are suggested in ‘injection molding performance evaluation’ of Table 2.

As appreciated from Table 2, the mixtures of metal powder and binder comprising 25 to 55% by volume of the binder having 40 to 60% by weight of wax and 60 to 40% by weight of polymers and 75 to 45% by volume of the metal powder have good injection molding performance.

The metal injection molded products, which are stably molded, are subjected to supercritical debinding and thermal debinding.

In the case where titanium hydride is used as the metal powder, the debinding process is performed under hydrogen atmosphere. Even though no specific description is suggested in Table 2, when even the metal injection molded products stably molded are subjected to the debinding process under non-hydrogen atmosphere, the sintered states of the basic metallic frame products may be defective. This is because hydrogen is lost even the debinding process so that even the metal injection molded products stably molded may be deformed in shape after sintered.

The metal injection molded products after the debinding are fixed to the support means, as shown in FIG. 2 and then subjected to sintering, thereby making basic metallic frame products.

According to the present invention, further, in the case of using titanium hydride for the metal powder, hydrogen is lost, when sintered, so that the metal injection molded product using titanium hydride powder may shrink to a larger extent than the metal injection molded product using the stainless steel alloy powder. Accordingly, if the molded side walls and the inside corner supports are disposed to come into close contact with each other (that is, if a restrained gap therebetween is 0%), the molded side walls may be twisted or cracked during the sintering process. At the time when the debinded metal injection molded product is fixed to the support means, therefore, there is a need to keep a given distance between the insides of the corners of the molded side walls and the inside corner supports.

The given distance between the insides of the corners of the molded side walls and the inside corner supports is represented as a restrained gap, and the restrained gap is defined as the half of the value obtained by dividing a distance between the insides of the corners of the molded side walls and the inside corner supports by a molded product length in a direction of the distance between the insides of the corners of the molded side walls and the inside corner supports and then multiplying 100 by the divided value.

As appreciated from Table 2, in the case where the metal injection molded products comprising 25 to 55% by volume of the binder having 40 to 60% by weight of wax and 60 to 40% by weight of polymers and 75 to 45% by volume of the metal powder are fixed to the support means in such a way as to have the restrained gaps in the range of 1.5 to 5.5%, desired basic metallic frame products are obtained, and especially in the case where the restrained gaps are in the range of 1.5 to 5%, good quality basic metallic frame products are obtained.

TABLE 2
Embodiments of metal injection molded products using mixtures of
titanium hydride powder and binder

| | Mixtures for metal injection | | | | | | |
|---|---|---|---|---|---|---|---|
| | molding (% by volume) | | | | | | |
| | | Binder | | | | | |
| | | | Composition | | | | |
| | | | ratio (% by | | Injection | | |
| | Titanium | | weight) | | molding | Restrained | Sintered |
| Nos. | hydride | | Wax | Polymers | performance | gaps | states |
| Embodiment | 30 | 70 | 30 | 70 | X | | |
| 18 | | | | | | | |
| Embodiment | 35 | 65 | 40 | 60 | ◯ | 0.5% | X |
| 19 | | | | | | | |
| Embodiment | 40 | 60 | 50 | 50 | ◯ | 1% | X |
| 20 | | | | | | | |
| Embodiment | 45 | 55 | 60 | 40 | ◯ | 1.5% | ◯ |
| 21 | | | | | | | |
| Embodiment | 50 | 50 | 70 | 30 | X | | |
| 22 | | | | | | | |
| Embodiment | 50 | 50 | 30 | 70 | X | | |
| 23 | | | | | | | |
| Embodiment | 55 | 45 | 40 | 60 | ◯ | 3% | ◯ |
| 24 | | | | | | | |
| Embodiment | 55 | 45 | 50 | 50 | ◯ | 3.5% | ◯ |
| 25 | | | | | | | |
| Embodiment | 60 | 40 | 60 | 40 | ◯ | 4% | ◯ |
| 26 | | | | | | | |
| Embodiment | 60 | 40 | 70 | 30 | X | | |
| 27 | | | | | | | |
| Embodiment | 65 | 35 | 30 | 70 | Δ | 5% | Δ |
| 28 | | | | | | | |
| Embodiment | 70 | 30 | 40 | 60 | ◯ | 4% | ◯ |
| 29 | | | | | | | |
| Embodiment | 70 | 30 | 40 | 60 | ◯ | 5.5% | Δ |
| 30 | | | | | | | |
| Embodiment | 75 | 25 | 50 | 50 | ◯ | 6% | Δ |
| 31 | | | | | | | |
| Embodiment | 30 | 70 | 60 | 40 | ◯ | 0% | X |
| 32 | | | | | | | |
| Embodiment | 35 | 65 | 70 | 30 | X | | |
| 33 | | | | | | | |
| Embodiment | 40 | 60 | 30 | 70 | X | | |
| 34 | | | | | | | |
| Embodiment | 45 | 55 | 40 | 60 | ◯ | 1.5% | ◯ |
| 35 | | | | | | | |
| Embodiment | 50 | 50 | 50 | 50 | ◯ | 2% | ◯ |
| 36 | | | | | | | |
| Embodiment | 50 | 50 | 60 | 40 | ◯ | 2.5% | ◯ |
| 37 | | | | | | | |
| Embodiment | 55 | 45 | 70 | 30 | X | | |
| 38 | | | | | | | |
| Embodiment | 55 | 45 | 30 | 70 | X | | |
| 39 | | | | | | | |
| Embodiment | 60 | 40 | 40 | 60 | ◯ | 4% | ◯ |
| 40 | | | | | | | |
| Embodiment | 60 | 40 | 50 | 50 | ◯ | 4.5% | ◯ |
| 41 | | | | | | | |
| Embodiment | 65 | 35 | 60 | 40 | ◯ | 5% | Δ |
| 42 | | | | | | | |
| Embodiment | 70 | 30 | 70 | 30 | Δ | 5.5% | Δ |
| 43 | | | | | | | |
| Embodiment | 75 | 25 | 30 | 70 | Δ | 6% | Δ |
| 44 | | | | | | | |

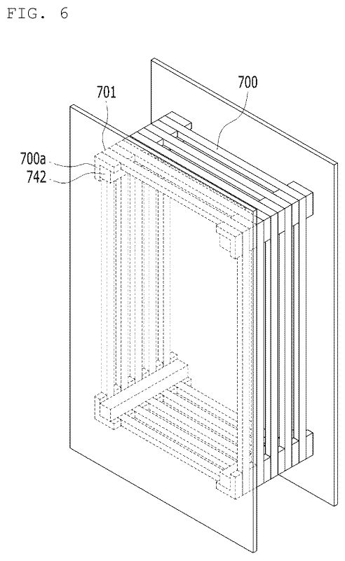

FIGS. 4 to 6 show metal injection molded systems according to other embodiments of the present invention in which two or more metal injection molded products are stacked on top of one another and sintered at a time.

Referring to FIG. 4, a metal injection molded system is configured to allow a plurality of metal injection molded products 200 to be disposed correspondingly on a plurality of support means 614 in such a way as to allow the insides of corners 201 of the respective metal injection molded products disposed on the corresponding support means to be fixed to multi-connection inside corner supports 242. That is, the plurality of support means are coupled to one another in a stacked manner in thickness directions of the metal injection molded products, thereby producing a plurality of basic metallic frame products at a time.

Referring to FIG. 5, a metal injection molded system is configured to allow a plurality of multi-connection inside corner supports 742 to be disposed on one support means 714 in such a way as to allow a plurality of metal injection molded products 700 to be stacked on top of one another in height directions thereof, while being spaced apart from one another by means of spacing members 700a arranged on the multi-connection inside corner supports.

Referring to FIG. 6, a metal injection molded system is configured to allow a pair of support means spaced apart from each other in parallel to each other to be disposed vertical to the ground in such a way as to allow multi-connection inside corner supports 742 to be fixed vertically to the two support means so that a plurality of metal injection molded products 700 are stacked on top of one another, while being spaced apart from one another by means of spacing members 700a arranged on the multi-connection inside corner supports. That is, the insides of the corners of the plurality of metal injection molded products are disposed vertically to the ground in a stacked manner in such a way as to hang on the multi-connection inside corner supports 742.

The support means, the multi-connection inside corner supports, and the spacing members of the metal injection molded systems are configured to be easily separated from the metal injection molded products after the sintering process, in the same manner as the inside corner supports and the support means as mentioned above. That is, the multi-connection inside corner supports, the support means, and the spacing members include a ceramic material, or multi-connection inside corner supports, the support means, and the spacing members are treated to have no reaction to the molded side walls of the metal injection molded products.

The treatment through which the multi-connection inside corner supports, the support means, and the spacing members do not react to the molded side walls is performed by selecting one among a method in which the multi-connection inside corner supports, the support means, and the spacing members are entirely made of an unreactive material that does not react to the molded side walls, a method in which an unreactive material that does not react to the molded side walls is applied to the outer surfaces of the multi-connection inside corner supports, the support means, and the spacing members, and a method in which an unreactive material or solution is applied to any one or more surfaces where the multi-connection inside corner supports, the support means, and the spacing members are brought into contact with the molded side walls and then dried or sintered. The unreactive material includes any one of ceramic powder and graphite powder or a combination of two or more thereof.

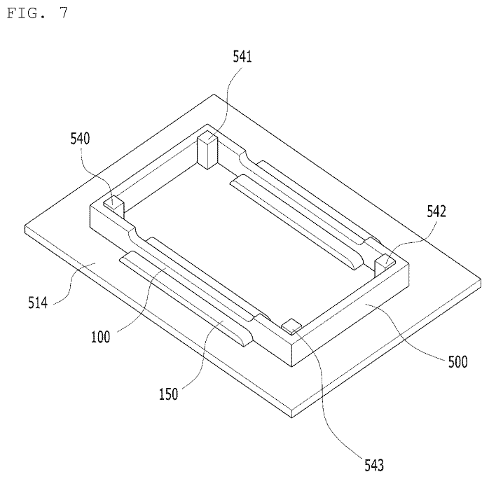

The present invention may further include various means for supporting the molded side walls of the metal injection molded product, and such an embodiment is suggested in FIG. 7. As shown, a metal injection molded system according to the present invention further includes guide members 150 adapted to make the thicknesses, widths, etc. of the molded side walls differently formed in shape, and the guide members 150 as shown in FIG. 7 support the thickness directions of the molded side walls 100 to allow portions where the molded side walls are low in thickness to be formed when sintered. Through the guide members 150, the basic metallic frame products may be differently changed in shape to make the metallic frames having various shapes.

The guide members as shown in FIG. 7 support the thickness directions of the molded side walls of the metal injection molded product, but of course, the guide members may support the inner surfaces, the outer surfaces, the inner and outer surfaces, or the width directions of the molded side walls. If the molded side walls are long to be hard to be supported only through the inside corner supports, further, the guide members are additionally disposed on portions of the molded side walls to prevent the molded side walls from being deformed when sintered.

The guide members are treated to have no reaction to the metal injection molded product during the sintering process, and the above-mentioned same treatment may be applied to the guide members.

A method for manufacturing a basic metallic frame product according to the present invention is carried out to allow the metal injection molded product to be subjected to the sintering process in a state where the support means has the inside corner supports adapted to fix the insides of the corners of the metal injection molded product, so that the changes in the length of the metal injection molded product during the sintering process are minimized to stably make the metallic frame product having excellent dimension precision.

As a result, the number of post-machining processes is remarkably reduced in making the metallic frame product having the desired shape, thereby greatly saving the manufacturing time and cost and enabling mass production.

Although various aspects of the disclosed method for manufacturing a basic metallic frame product have been shown and described, modifications may occur to those skilled in the art upon reading the specification. The present application includes such modifications and is limited only by the scope of the claims.

### INDUSTRIAL APPLICABILITY

The present invention relates to the metal injection molded product used to make the metallic frame inserted into a casing of an electronic product such as a smartphone, a smart key, and the like, the metal injection molded system for making the basic metallic frame product using the metal injection molded product, and the method for manufacturing the basic metallic frame product using the system, thereby being excellent in the industrial applicability thereof.

1. A metal injection molded system comprising:
a metal injection molded product having molded side walls to make a metallic frame in such a way as to allow the molded side walls to intersect to provide the metal injection molded product having a closed shape; and
a support means disposed at the insides of corners at which the molded side walls intersect to fix the molded side walls thereto so that the molded side walls are prevented from shrinking in longitudinal directions thereof during a sintering process.

2. The metal injection molded system according to claim 1,
wherein the support means comprises inside corner supports fixed to one surface thereof.

3. The metal injection molded system according to claim 2, wherein the support means is treated to have no reaction to the molded side walls.

4. The metal injection molded system according to claim 3, wherein the treatment through which the support means does not react to the molded side walls is performed by selecting one among (a) a method in which the support means is entirely made of an unreactive material that does not react to the molded side walls, (b) a method in which an unreactive material that does not react to the molded side walls is applied to the outer surface of the support means, and (c) a method in which an unreactive material or solution is applied to any one or more surfaces where the support means is brought into contact with the molded side walls and then dried or sintered.

5. The metal injection molded system according to claim 1,
wherein the metal injection molded product comprises a mixture of metal powder and a binder.

6. The metal injection molded system according to claim 5,
wherein the mixture of the metal powder and the binder comprises 45 to 75% by volume of the metal powder and 55 to 25% by volume of the binder.

7. The metal injection molded system according to claim 6, wherein the mixture of the metal powder and the binder comprises: 47.5 to 65% by volume of stainless alloy steel powder; and 52.5 to 35% by volume of the binder comprising 45 to 55% by weight of paraffin wax, 1 to 10% by weight of carnauba wax, 10 to 20% by weight of polypropylene, 25 to 35% by weight of polyacetal, and 1 to 10% by weight of amorphous polyalphaolefin.

8. The metal injection molded system according to claim 6, wherein the mixture of the metal powder and the binder comprises:
45 to 75% by volume of titanium hydride powder; and 55 to 25% by volume of the binder comprising 40 to 60% by weight of paraffin wax, 15 to 30% by weight of polypropylene, 10 to 30% by weight of polyethylene, and 1 to 10% by weight of amorphous polyalphaolefin.

9. The metal injection molded system according to claim 8, wherein a restrained gap between the support means and the metal injection molded product is in the range of 1.5 to 5.5%.

10. The metal injection molded system according to claim 2, wherein the metal injection molded product has polygonal or round corners, and the inside corner supports have the shapes corresponding to the insides of the polygonal or round corners.

11. The metal injection molded system according to claim 2, wherein a plurality of metal injection molded products fixed correspondingly to a plurality of support means are stacked on top of one another, and the inside corner supports are provided to the forms of multi-connection inside corner supports disposed to pass through the corresponding support means in such a way as to be locked onto the insides of the corners of the plurality of metal injection molded products.

12. The metal injection molded system according to claim 2, wherein a plurality of metal injection molded products are spaced apart from one another in a stacked manner by means of spacing members, and the inside corner supports fixed to the support means are provided to the forms of multi-connection inside corner supports locked onto the insides of the corners of the plurality of metal injection molded products.

13. The metal injection molded system according to claim 2, wherein two support means stand up to face each other, while a plurality of metal injection molded products are spaced apart from one another in a stacked manner by means of spacing members between the two support means, and the inside corner supports fixed to the two support means are provided to the forms of multi-connection inside corner supports locked onto the insides of the corners of the plurality of metal injection molded products.

14. The metal injection molded system according to claim 11, wherein the support means and the multi-connection inside corner supports are configured to have no reaction to the molded side walls.

15. The metal injection molded system according to claim 1, further comprising guide members for supporting any one or more among the inner surfaces, the outer surfaces, the inner and outer surfaces, the width directions, and the thickness directions of the molded side walls.

16. The metal injection molded system according to claim 15, wherein the guide members are configured to have no reaction to the molded side walls.

17. A method for manufacturing a basic metallic frame product, comprising the steps of:
designing a shape of a product to be made by metal injection molding;
making a mold based on the designed shape;
mixing metal powder and a binder to make a mixture of the metal powder and the binder;
injecting the mixture into the mold made according to the shape of the product to be made by the metal injection molding to make a metal injection molded product having molded side walls to make a metallic frame in such a way as to allow the molded side walls to intersect to provide the metal injection molded product having a closed shape;
allowing the metal injection molded product to be subjected to supercritical debinding and thermal debinding, fixed to support means disposed on the insides of corners at which the molded side walls intersect to prevent the molded side walls from shrinking in longitudinal directions thereof during a sintering process, and subjected to the sintering process; and
separating the basic metal frame product from the support means.

18. A basic metallic frame product made according to the method as defined in claim 17.
